(19) United States
(12) Patent Application Publication
(10) Pub. No.: US 2002/0072985 A1
(43) Pub. Date: Jun. 13, 2002

(54) Online international direct merchandising system

(76) Inventor: Juan Mauricio Castro, Phoenix, AZ (US)

Correspondence Address: JUAN MAURICIO CASTRO, 13440 N. 44th St # 2217, Phoenix, AZ, 85032, US

(21) Appl. No.: 09/736,492

(22) Filed: Dec. 13, 2000

(51) Int. Cl. G06F 17/60

(52) U.S. Cl. 705/26

(57) ABSTRACT

The purpose of this invention is to provide the means for merchants or manufacturers of goods throughout the world, the means to sell their products online when they do not have access to computers or/and Internet connections. This process provides the connection, the online store and support needed by the merchant or manufacturer to manage and sell their inventory on the World Wide Web without the creation and expense of an online store for each merchant or manufacturer.

### CROSS-REFERENCE TO RELATED APPLICATIONS

Not Applicable.

### STATEMENT REGARDING FEDERALLY SPONSORED RESEARCH OR DEVELOPMENT

Not Applicable. REFERENCE TO A MICROFICHE APPENDIX

Not Applicable.

### BACKGROUND OF THE INVENTION

The Classification Definition or subject matter of this invention is under classification: 705, Subclass: 26 for electronic shopping. This invention should be classified as a new process for online shopping and online distribution. There are no previous online shopping processes similar to this one; therefore no reference to any prior art is included.

### BRIEF SUMMARY OF THE INVENTION

This invention is an international computer network that provides the means for merchants without computers or/and online access, the ability to sell their goods through this process. The process is a system that allows merchants to directly manage their inventory through the use of a merchant username and password provided for the merchant's use in his indvidual country through a computer that is linked to the main server as a network terminal. Each computer terminal in each individual country is linked to the main server where the online store and all other information are stored. Each merchant can manage his/her own inventory and adjust it according to his/her level of desired participation in the online store. This process eliminates layers of transaction between the buyer and the merchant. Instead the system provided by this process becomes the only transaction between the buyer and merchant. The goods are distributed directly from the merchant to the buyer, without the use of additional warehousing or storing of inventory by anyone other than the merchant or manufacturer of the goods.

### BRIEF DESCRIPTION OF THE SEVERAL VIEWS OF THE DRAWING

Not Applicable.

### DETAILED DESCRIPTION OF THE INVENTION

The main purpose of the process invented is to support direct transactions between merchants and buyers. It works by providing the means for merchants without an online store, to sell their goods via the World Wide Web. The main server stores all the information from the online store about the merchants, goods sold by merchants as well as information from each remote terminal located in every country where the business operates. Once the goods are photographed and/or video recorded, they are inputted into the server, then priced according to the merchant's agreement and finally published on the website's online store. From this site buyers can browse the entire extent of any merchant's inventory by product category or country where the site operates. Each time an order is placed online and processed, the individual country terminal where the product is located receives the order and forwards it to the merchant who owns the goods. The merchant then ships the good(s) to the buyer according to the terms agreed upon by both the buyer and seller. The main server, which is linked to the online store by and ISP then processes all the final transactions according to the merchant's response and notifies the buyer. The merchant(s) can adjust their inventory at the terminal located in his/her country where new goods can be added and unsold inventory can be deleted. Every time inventory is adjusted or orders are placed, the main server connected to the online store sends this information to all the remote terminals All remote terminals receive and send data via a modem connection. DSL, Cable or T1 line connections will be used in countries where they are available.

1. What I claim as my invention is the process that enables a direct international connection between the merchants who own or manufacture the goods and the buyer: This is possible by the system of remote computer terminals and server(s). This creates the first process where merchants without their own online store or Internet presence can sell their goods to buyers around the world. This is the only process where merchants are allowed to manage their own inventory at a site not owned by the merchant. The information about the merchants and the online store including customers'orders and inventory available is hosted in the main server(s).
